(19) United States
(12) Patent Application Publication
(10) Pub. No.: US 2025/0272369 A1
(43) Pub. Date: Aug. 28, 2025

(54) INFORMATION PROCESSING DEVICE, MANAGEMENT METHOD, AND NON-TRANSITORY COMPUTER-READABLE STORAGE MEDIUM STORING PROGRAM

(71) Applicant: SEIKO EPSON CORPORATION, Tokyo (JP)

(72) Inventors: Toshiki ENDO, Matsumoto (JP); Keisuke HAMANO, Matsumoto (JP)

(21) Appl. No.: 19/060,840

(22) Filed: Feb. 24, 2025

(30) Foreign Application Priority Data
Feb. 26, 2024 (JP) 2024-026252

(51) Int. Cl. G06F 21/31

(52) U.S. Cl. CPC G06F 21/31

(57) ABSTRACT

An information processing device is an information processing device for managing an image forming device. The information processing device includes: a storage unit configured to store first authentication information for accessing the image forming device and second authentication information that is information obtained by updating the first authentication information; and an acquisition unit configured to acquire device information of the image forming device by accessing the image forming device, in which the acquisition unit acquires, when acquisition of the device information of the image forming device by access using the second authentication information fails, the device information of the image forming device using the first authentication information.

The present application is based on, and claims priority from JP Application Serial Number 2024-026252, filed Feb. 26, 2024, the disclosure of which is hereby incorporated by reference herein in its entirety.

### BACKGROUND

### 1. Technical Field

The present disclosure relates to an information processing device, a management method, and a non-transitory computer-readable storage medium storing a program.

### 2. Related Art

Simple Network Management Protocol (SNMP) is known as a standard protocol for managing devices in a Transmission Control Protocol (TCP)/Internet Protocol (IP) network environment. By using the SNMP, for example, a management device can acquire device information of a device to be managed. In the SNMP, in order to collect device information on the device to be managed, the management device needs to use authentication information set in the device to be managed. In general, in order to operate a system more securely, it is important to update authentication information required to access a device. In this regard, for example, JP-A-2003-288189 discloses a technique of periodically updating authentication information for using a printer connected to a network.

Authentication information set in each of the devices to be managed in order for the management device to manage the device to be managed may also be updated periodically or irregularly. When new authentication information is set in the device to be managed, the management device can access the device to be managed by using the new authentication information. However, for some reason, new authentication information, that is, updated authentication information may not be set in the device to be managed. In this case, the management device may not be able to access the device to be managed.

### SUMMARY

An information processing device according to the present disclosure is an information processing device for managing an image forming device. The information processing device includes: a storage unit configured to store first authentication information for accessing the image forming device and second authentication information that is information obtained by updating the first authentication information; and an acquisition unit configured to acquire device information of the image forming device by accessing the image forming device, in which the acquisition unit acquires, when acquisition of the device information of the image forming device by access using the second authentication information fails, the device information of the image forming device using the first authentication information.

A management method according to the present disclosure is a management method for managing an image forming device. The management method includes: storing, in a storage unit in advance, first authentication information for accessing the image forming device and second authentication information that is information obtained by updating the first authentication information; and acquiring device information of the image forming device using the first authentication information when acquisition of the device information of the image forming device by access using the second authentication information fails.

A non-transitory computer-readable storage medium storing a program according to the present disclosure causes a computer of an information processing device for managing an image forming device to execute operations including: a storage processing step of storing, in a storage unit, first authentication information for accessing the image forming device and second authentication information that is information obtained by updating the first authentication information; and an acquisition step of acquiring device information of the image forming device by accessing the image forming device, in which in the acquisition step, when acquisition of the device information of the image forming device by access using the second authentication information fails, the device information of the image forming device is acquired using the first authentication information.

### BRIEF DESCRIPTION OF THE DRAWINGS

FIG. 1 is a diagram showing a configuration of a management system according to an embodiment.

FIG. 2 is a block diagram showing an example of the functional configuration of an information processing device according to the embodiment.

FIG. 3 is a diagram showing an example of information stored in a setting DB.

FIG. 4 is a diagram showing an example of information stored in a history information DB.

FIG. 5 is a diagram showing an example of information displayed on a UI device.

FIG. 6 is a block diagram showing an example of a hardware configuration of the information processing device according to the embodiment.

FIG. 7 is a flowchart showing a flow of processing related to acquisition of device information.

### DESCRIPTION OF EMBODIMENTS

An embodiment will be described below with reference to the drawings. To clarify the description, omission and simplification have been made as appropriate in the description and the drawings below. In the drawings, the same elements are denoted by the same reference signs, and the redundant description thereof is omitted as necessary.

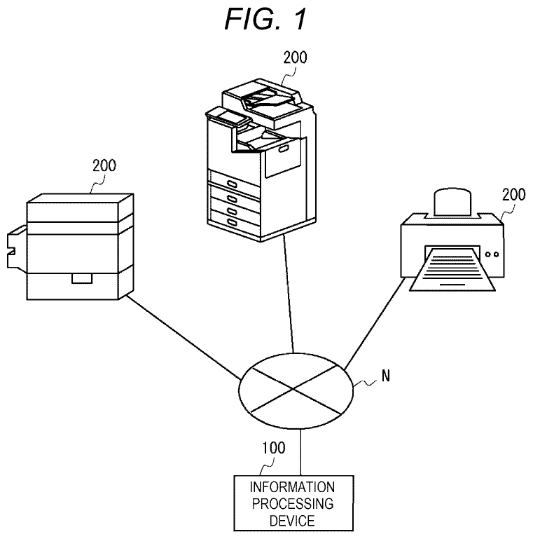

FIG. 1 is a diagram showing a configuration of a management system 1 according to the embodiment. The management system 1 includes an information processing device 100 as a management device that manages an image forming device 200, and the image forming device 200 managed by the information processing device 100. The information processing device 100 and the image forming device 200 are connected to a network N such as the Internet.

The image forming device 200 is, for example, a device having a printing function, that is, a printer. The image forming device 200 may not necessarily have the printing function. The image forming device 200 may have one or more other functions instead of the printing function or in addition to the printing function. For example, the image forming device 200 may have a scanner function. In the example shown in FIG. 1, three image forming devices 200 are shown as the image forming device managed by the information processing device 100, but the number of image forming devices 200 managed by the information processing device 100 is not limited to three and may be any number. The image forming devices 200 managed by the information processing device 100 may be image forming devices of the same model, or may be image forming devices of different models.

As described above, the information processing device 100 is a device for managing the image forming device 200. The information processing device 100 may be referred to as a management device. The information processing device 100 manages the image forming device 200 by acquiring device information on the image forming device 200 using SNMP. Here, the device information is information indicating a state of the image forming device 200. The device information may be, for example, a state indicating a state related to a printing function of the image forming device 200. Specifically, the device information may be information indicating a remaining number of consumables (for example, ink) used for printing, or may be information indicating an error (for example, paper jam) occurring in the image forming device 200. These are merely examples of the device information, and any device information may be acquired.

In order to achieve communication according to the SNMP, the information processing device 100 and the image forming device 200 need to use the same authentication information. More specifically, the information processing device 100 needs to access the image forming device 200 using the same authentication information as authentication information set in the image forming device 200. Here, the authentication information is information used in authentication processing executed by the image forming device 200 to confirm whether processing of acquiring the device information of the image forming device 200 by the information processing device 100 is processing executed by a device having legitimate authority. The authentication information can be said to be information necessary for the information processing device 100 to access the image forming device 200. Only when the information processing device 100 accesses the image forming device 200 using the same authentication information as the authentication information set in the image forming device 200, the image forming device 200 transmits device information to the information processing device 100 assuming that the processing is executed by a device having legitimate authority.

In the embodiment, as an example, the information processing device 100 and the image forming device 200 use SNMP version v3. Therefore, in the embodiment, the authentication information includes the following information according to a specification of the SNMP version v3. That is, in the embodiment, the authentication information includes information designating a user name, information designating an authentication algorithm, information indicating an authentication password, information designating an encryption algorithm, information indicating an encryption password, and a context name. Other versions of SNMP may also be used. For example, in SNMP version v1 or version v2c, when accessing the image forming device 200, the information processing device 100 needs to transmit an SNMP community name set in the image forming device 200 to the image forming device 200. Only when the information processing device 100 uses an appropriate SNMP community name, access to the image forming device 200 is successful. Therefore, in the version v1 or the version v2c, the SNMP community name required for access can be said to be a type of authentication information.

In order to securely operate the management system 1, the authentication information set in the image forming device 200 is updated periodically or irregularly by an update operation by an administrator. In the embodiment, in order to facilitate management of the authentication information set in the image forming device 200 and the update operation of the authentication information, the authentication information is set in each image forming device 200 so that all image forming devices 200 in the management system 1 use the same authentication information. Accordingly, when the update operation of the authentication information is performed, the authentication information common to all the image forming devices 200 is set in each image forming device 200. Therefore, in the embodiment, it can be said that the information processing device 100 is a device that acquires the device information of each of the image forming devices 200 by accessing each of the image forming devices 200 using the authentication information set in common to the plurality of image forming devices 200.

In this way, in the embodiment, the management system 1 is a system having the following features. Each of the plurality of image forming devices 200 is operated so that common authentication information according to SNMPv3 is set. The information processing device 100 holds the common authentication information, accesses each image forming device 200 using the common authentication information, and acquires device information from each image forming device 200.

The system having the above-described features has the following problems. When common authentication information (first authentication information) set in each image forming device 200 is updated to new common authentication information (second authentication information), new authentication information may not be set in some of the image forming devices 200. That is, in some of the image forming devices 200, the second authentication information that is new authentication information may not be reflected, and the first authentication information may continue to be used. In such a case, when a device used as the management device changes the authentication information used for acquiring the device information from the image forming device 200 from the first authentication information to the second authentication information, the device cannot acquire the device information from the image forming device 200 in which the first authentication information remains set. Therefore, in the embodiment, the information processing device 100 having a feature to solve such a problem will be described. For example, in the following case, an event occurs in which the authentication information set in the image forming device 200 is not updated. When new authentication information is set, in a case where the image forming device 200 is powered off, the updated authentication information is not set in the image forming device 200. When an error such as a packet loss occurs during communication for setting new authentication information, updating of the authentication information in the image forming device 200 fails. When the number of image forming devices 200 is large, it is necessary to perform an authentication information update operation for the image forming devices 200 over a plurality of schedules, and thus old authentication information is continuously used in the image forming device 200 for which the update operation is not completed.

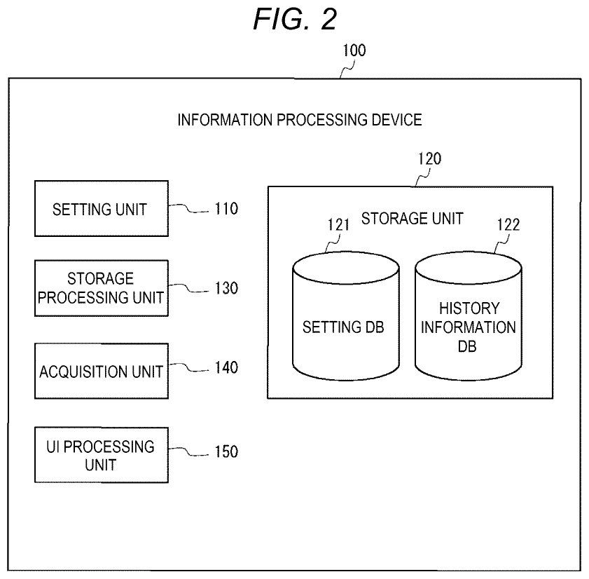

FIG. 2 is a block diagram showing an example of a functional configuration of the information processing device 100. As shown in FIG. 2, the information processing device 100 includes a setting unit 110, a storage unit 120, a storage processing unit 130, an acquisition unit 140, and a UI processing unit 150.

The setting unit 110 sets authentication information common to all the image forming devices 200 in the management system 1 to each of the image forming devices 200. That is, the setting unit 110 sets new authentication information in the image forming device 200 or updates the authentication information set in the image forming device 200. The setting unit 110 sets, for example, new authentication information designated by a user via a UI device 161 described later in the image forming device 200. The setting unit 110 accesses the image forming device 200 using authentication information currently set in the image forming device 200, thereby setting updated authentication information. As described above, the updating of the authentication information is not always successful at the same timing in all the image forming devices 200.

The storage unit 120 is a storage area for storing information used by the information processing device 100 to acquire device information from the image forming device 200. In the embodiment, the storage unit 120 includes a setting DB (database) 121 and a history information DB (database) 122.

The setting DB 121 is an area in which authentication information set in each image forming device 200 by the setting unit 110 as authentication information common to all the image forming devices 200 is stored. Every time the setting unit 110 sets new authentication information in the image forming device 200, the new authentication information is added to the setting DB 121. Therefore, the setting DB 121 stores not only the latest authentication information but also past authentication information. The setting DB 121 is a specific example of a storage unit that stores the first authentication information for accessing the image forming device 200 and the second authentication information that is information obtained by updating the first authentication information.

The history information DB 122 is an area in which information indicating authentication information used to acquire device information of the image forming device 200 is stored in association with identification information of the image forming device 200. That is, the history information DB 122 is an area in which information indicating authentication information for which device information of the image forming device 200 is successfully acquired and identification information of the image forming device 200 are stored in association with each other. More specifically, in the history information DB 122, only information indicating the authentication information used by the acquisition unit 140 when the acquisition of the device information of the image forming device 200 is successful most recently is stored in association with the identification information of the image forming device 200. Therefore, in the history information DB 122, the number of pieces of information indicating the authentication information stored in association with the identification information of one image forming device 200 is one or less. For example, the information indicating the authentication information may be information for specifying one piece of authentication information from among various pieces of authentication information, and may be, for example, identification information for identifying the authentication information, or the authentication information itself.

The storage processing unit 130 stores information in the storage unit 120. In the embodiment, every time the setting unit 110 sets new authentication information in the image forming device 200, the storage processing unit 130 adds new authentication information to the setting DB 121. Therefore, the setting DB 121 stores the updated authentication information every time the authentication information is updated. In other words, every time new authentication information is introduced into the management system 1, the setting DB 121 stores newly introduced authentication information as updated authentication information. In the embodiment, the storage processing unit 130 stores the authentication information together the information indicating a priority order in the setting DB 121. The priority order indicates which authentication information stored in the setting DB 121 is to be preferentially used when the authentication information stored in the setting DB 121 is used. In the embodiment, specifically, the priority order is an order according to an order in which the authentication information is updated. More specifically, the priority order is set for each piece of authentication information such that newer authentication information has a higher priority, that is, is used with higher priority.

In the embodiment, information indicating a priority order is automatically assigned to the authentication information stored in the setting DB 121 by processing of the storage processing unit 130, but information indicating a priority order may be set for each piece of the authentication information stored in the setting DB 121 by the administrator using the information processing device 100. In the embodiment, the storage processing unit 130 automatically adds new authentication information to the setting DB 121 every time the setting unit 110 sets the new authentication information in the image forming device 200, but the authentication information may also be stored in the setting DB 121 by an operation of the administrator.

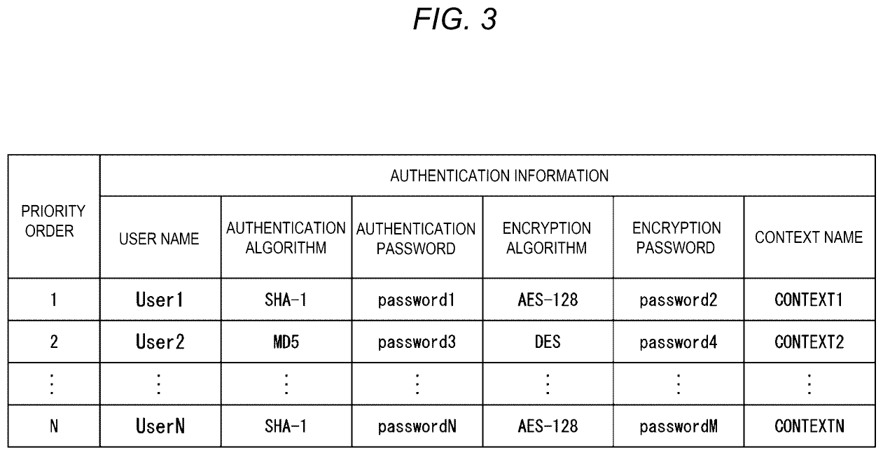

FIG. 3 is a diagram showing an example of information stored in the setting DB 121. In the example shown in FIG. 3, the setting DB 121 stores N different pieces of authentication information. As shown in FIG. 3, a priority order is set for each piece of authentication information. In the example shown in FIG. 3, the authentication information at a top of a table has a higher priority, and thus the authentication information at the top of the table indicates newer authentication information.

When the acquisition unit 140 acquires device information of the image forming device 200, the storage processing unit 130 stores identification information of the image forming device 200 and information indicating the authentication information used to acquire the device information in association with each other as history information in the history information DB 122. That is, when the acquisition unit 140 successfully acquires the device information, the storage processing unit 130 saves, in the history information DB 122, identification information of the image forming device 200 and information indicating the authentication information used for access at the time of acquiring the device information, in association with each other. In particular, when the acquisition unit 140 acquires the device information of the image forming device 200 using authentication information different from authentication information specified based on history information stored in the history information DB 122, the storage processing unit 130 updates the history information with information indicating the authentication information used to acquire the device information. This will be described in more detail. In the present disclosure, among the plurality of image forming devices 200 managed by the information processing device 100, one image forming device 200 whose device information is to be acquired by the acquisition unit 140 is referred to as a target device. For example, it is assumed that identification information of the image forming device 200 as the target device and information indicating authentication information B are stored in the history information DB 122 in association with each other. At this time, when the acquisition unit 140 successfully acquires the device information of the target device using authentication information A different from the authentication information B, the storage processing unit 130 changes the information associated with the identification information of the target device from the information indicating the authentication information B to information indicating the authentication information A. That is, the storage processing unit 130 updates information indicating the history information that is associated with the identification information of the target device. Accordingly, when the device information is acquired from the target device next time, the device information can be efficiently acquired using the history information.

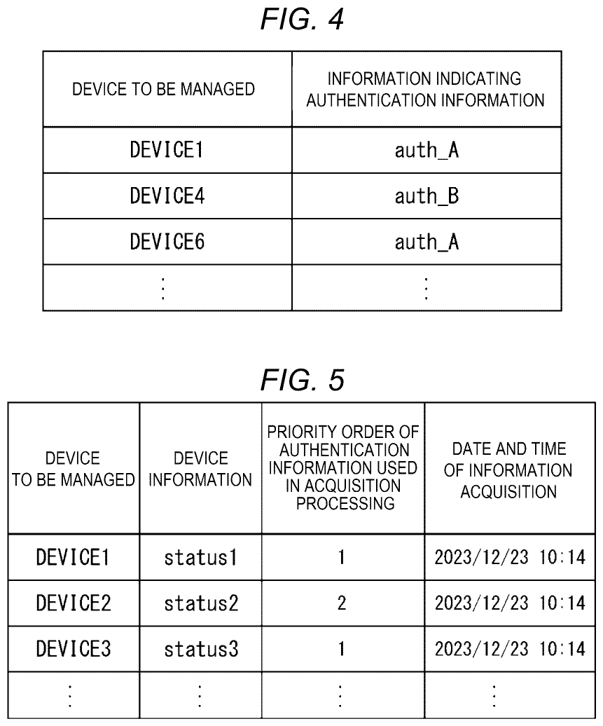

FIG. 4 is a diagram showing an example of information stored in the history information DB 122. As shown in FIG. 4, the history information DB 122 saves, as history information, identification information of the image forming device 200 managed by the information processing device 100 and information indicating authentication information in association with each other. Only when the acquisition unit 140 successfully acquires the device information of the image forming device 200, the history information of the image forming device 200 is saved in the history information DB 122. Therefore, for the image forming device 200 for which there is no record of successfully acquiring the device information, there is no history information in the history information DB 122.

The acquisition unit 140 accesses the image forming device 200 and acquires device information of the image forming device 200. In the embodiment, in particular, the acquisition unit 140 accesses each of the plurality of image forming devices 200 and acquires the device information of the image forming device 200. At this time, the acquisition unit 140 accesses the image forming device 200 using authentication information. When the authentication information used by the image forming device 200 matches authentication information set in the image forming device 200 as an access destination, acquisition of the device information from the image forming device 200 is successful. However, when the authentication information used by the image forming device 200 is different from the authentication information set in the image forming device 200 as the access destination, the acquisition of the device information from the image forming device 200 fails. For example, it is assumed that the acquisition unit 140 accesses each image forming device 200 using the updated authentication information (second authentication information) in a situation where the authentication information is not updated in some of the image forming devices 200 among all image forming devices 200 managed by the information processing device 100. In this case, the acquisition unit 140 succeeds in acquiring the device information from the image forming device 200 in which the updated authentication information (second authentication information) is set. However, the acquisition unit 140 fails to acquire device information from the image forming device 200 in which the authentication information before update (first authentication information) is still set. Therefore, in the embodiment, when the acquisition of the device information of the image forming device 200 by access using the updated authentication information (second authentication information) fails, the acquisition unit 140 acquires the device information of the image forming device 200 using the authentication information before the update (first authentication information). That is, after trying to acquire the device information of the image forming device 200 using the second authentication information, the acquisition unit 140 attempts to acquire the device information using the first authentication information for the image forming device 200 from which acquisition of the device information using the second authentication information fails. Accordingly, even in a situation in which authentication information is not updated in some of the image forming devices 200 managed by the information processing device 100, it is possible to acquire device information from each image forming device 200. In the embodiment, acquisition processing of the acquisition unit 140 described above is executed when history information about a target device (that is, one image forming device 200 from which an attempt is made to acquire device information) does not exist in the history information DB 122.

When the history information of the target device exists in the history information DB 122, the acquisition unit 140 first attempts to acquire the device information of the target device using the authentication information specified based on the history information among the authentication information stored in the setting DB 121. That is, when newly acquiring the device information of the image forming device 200, the acquisition unit 140 specifies authentication information used to access the image forming device 200 based on the history information stored in the history information DB 122. Accordingly, authentication information that has a record of successfully acquiring device information is used preferentially, and thus occurrence of failure in acquiring device information can be reduced. In other words, occurrence of unnecessary communication can be reduced.

When the acquisition of the device information of the target device using the authentication information specified based on the history information fails, the acquisition unit 140 acquires the device information of the target device using the authentication information selected according to a predetermined priority order among the authentication information stored in the setting DB 121. More specifically, in this case, the acquisition unit 140 attempts to acquire the device information of the target device by using the authentication information stored in the setting DB 121 in order from authentication information having the highest priority. Accordingly, the acquisition unit 140 can find and use newly set authentication information in the target device. Therefore, even when acquisition of the device information using the authentication information specified based on the history information fails, the device information can be acquired.

The UI processing unit 150 executes processing related to a user interface. For example, the UI processing unit 150 executes processing of receiving an instruction or information input from a user (for example, an administrator) via the UI device 161 described later. The UI processing unit 150 executes processing of outputting information using the UI device 161 described later. FIG. 5 is a diagram showing an example of information displayed on the UI device 161 by the processing of the UI processing unit 150. The UI processing unit 150 executes, for example, processing of displaying a list of device information of each image forming device 200 that is a device to be managed by the information processing device 100. That is, the UI processing unit 150 displays the device information of the image forming device 200 acquired by the acquisition unit 140 on the UI device 161. As shown in FIG. 5, the UI device 161 may indicate a priority order set in the authentication information used to acquire the device information by associating the authentication information used to acquire the device information with the identification information of the image forming device 200 so that the administrator can recognize the authentication information. The UI processing unit 150 can also indicate any information in association with the identification information of the image forming device 200. For example, as shown in FIG. 5, the UI processing unit 150 may indicate a date and time the device information is acquired. When there is an image forming device 200 from which the device information cannot be acquired, the UI processing unit 150 may display information indicating an error in acquisition of the device information instead of displaying the device information of the image forming device 200.

The UI processing unit 150 can display not only device information but also any information on the UI device 161. For example, the UI processing unit 150 may display, on the UI device 161, a UI screen on which a user sets a priority order for each piece of authentication information stored in the setting DB 121.

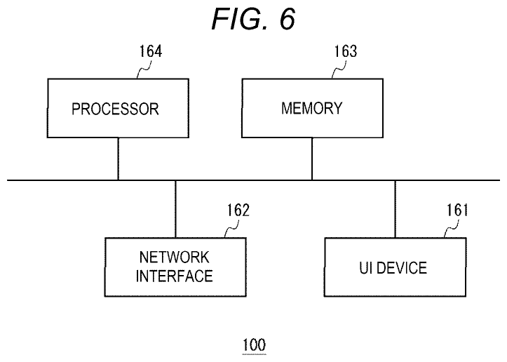

Next, a hardware configuration of the information processing device 100 will be described. FIG. 6 is a block diagram showing an example of the hardware configuration of the information processing device 100. As shown in FIG. 6, the information processing device 100 includes the UI device 161, a network interface 162, a memory 163, and a processor 164.

The UI device 161 is a device functioning as a user interface. Specifically, the UI device 161 is implemented by a display that displays various kinds of information and an input device such as a keyboard or a pointing device that receives an input operation from a user. The UI device may be implemented as a touch panel in which a display and an input device are integrated together.

The network interface 162 is used to perform communication via the network N. The network interface 162 may include, for example, a network interface card (NIC).

The memory 163 is implemented by, for example, a combination of a volatile memory and a nonvolatile memory. The memory 163 is used to store a program or the like executed by the processor 164. The storage unit 120 described above may be implemented by a storage device such as the memory 163. The memory 163 may include a plurality of memories.

The processor 164 reads a program from the memory 163 and executes the program. Accordingly, the processor 164 implements functions of the setting unit 110, the storage processing unit 130, the acquisition unit 140, and the UI processing unit 150 described above. The processor 164 may be, for example, a microprocessor, a microprocessor unit (MPU), or a central processing unit (CPU). The processor 164 may include a plurality of processors. In this way, the information processing device 100 has functions as a computer.

The program includes an instruction group (or software codes) for causing a computer to perform one or more of the functions explained in the embodiment when the program is read in the computer. The program may be stored in a non-transitory computer-readable medium or a tangible storage medium. Not as a limitation but as an example, the computer-readable medium or the tangible storage medium includes a random-access memory (RAM), a read-only memory (ROM), a flash memory, a solid-state drive (SSD), or devices based on other memory technologies, a CD-ROM, a digital versatile disc (DVD), a Blu-ray (trademark registered) disc, or other optical disc storages, a magnetic cassette, a magnetic tape, a magnetic disk storage or other magnetic storage devices. The program may be transmitted on a transitory computer-readable medium or a communication medium. Not as a limitation but as an example, the transitory computer-readable medium or the communication medium includes an electric, optical, or acoustic propagation signal or a propagation signal of another form.

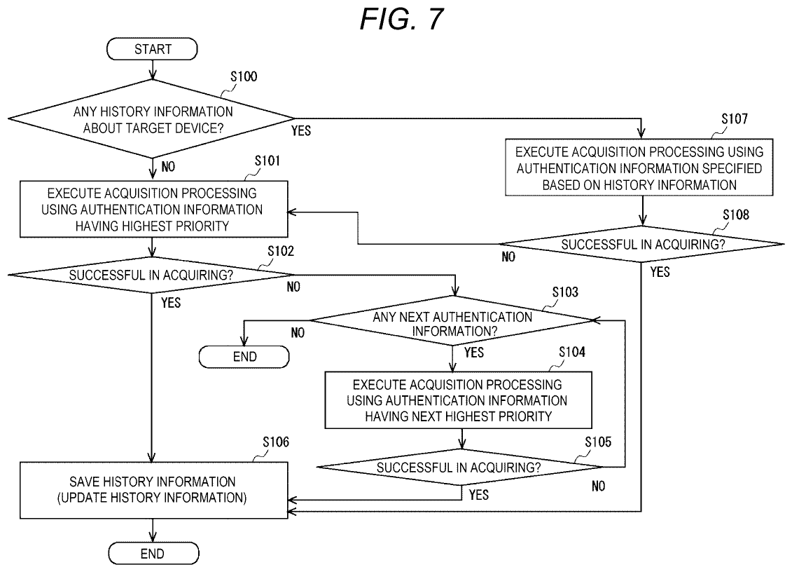

Next, a flow of processing of the information processing device 100 related to acquisition of device information will be described. FIG. 7 is a flowchart showing a flow of processing of the information processing device 100 related to acquisition of device information. Hereinafter, the flow of processing will be described with reference to FIG. 7.

In step S100, the acquisition unit 140 determines whether history information about a target device exists in the history information DB 122. When the history information about the target device does not exist in the history information DB 122, the processing proceeds to step S101. For example, when the device information of the target device is acquired for the first time, the processing proceeds to step S101. In contrast, when the history information about the target device exists in the history information DB 122, the processing proceeds to step S107. For example, when there is a record of successfully acquiring the device information of the target device, the processing proceeds to step S107.

In step S101, the acquisition unit 140 executes acquisition processing of acquiring the device information of the target device using authentication information having the highest priority among authentication information stored in the setting DB 121. That is, the acquisition unit 140 attempts to acquire the device information from the target device by accessing the target device using the authentication information having the highest priority. In the acquisition processing, when the device information of the target device is successfully acquired (YES in step S102), the processing proceeds to step S106. In contrast, when the acquisition of the device information of the target device fails (NO in step S102), the processing proceeds to step S103.

In step S103, the acquisition unit 140 determines whether authentication information having the next highest priority exists in the setting DB 121. When the authentication information having the next highest priority does not exist in the setting DB 121 (NO in step S103), that is, when the processing of acquiring the device information is attempted for all authentication information stored in the setting DB 121, the processing ends. In contrast, when the authentication information having the next highest priority exists in the setting DB 121, the processing proceeds to step S104.

In step S104, the acquisition unit 140 executes acquisition processing of acquiring the device information of the target device using the authentication information having the next highest priority among the authentication information stored in the setting DB 121. That is, the acquisition unit 140 attempts to acquire the device information from the target device by accessing the target device using the authentication information determined to exist in the setting DB 121 in step S103. In the acquisition processing, when the device information of the target device is successfully acquired (YES in step S105), the processing proceeds to step S106. In contrast, when the acquisition of the device information of the target device fails (NO in step S105), the processing returns to step S103, and the above-described processing is repeated.

When the device information of the target device is successfully acquired, the storage processing unit 130 saves the history information in the history information DB 122 in step S106. That is, the storage processing unit 130 saves, in the history information DB 122, the identification information of the target device and information indicating the authentication information for which the device information is successfully acquired, in association with each other. When the history information about the target device already exists in the history information DB 122, the storage processing unit 130 updates the history information saved in the history information DB 122. For example, when the processing proceeds to this step after it is determined in step S100 that history information about the target device exists in the history information DB 122, the history information is updated.

In step S100, when it is determined that the history information about the target device exists in the history information DB 122, the acquisition unit 140 executes processing of acquiring the device information of the target device using authentication information specified based on the history information of the target device saved in the history information DB 122. That is, when the processing proceeds to step S107, the acquisition unit 140 attempts to acquire the device information from the target device by accessing the target device using the authentication information specified based on the history information. In the acquisition processing, when the device information of the target device is successfully acquired (YES in step S108), the processing proceeds to step S106 described above. That is, the history information of the history information DB 122 is updated for the target device. In contrast, when the acquisition of the device information of the target device fails (NO in step S108), the processing proceeds to step S101 described above. That is, in this case, the acquisition unit 140 attempts to acquire the device information of the target device by sequentially using the authentication information saved in the setting DB 121 according to a priority order. In this case, use of the authentication information for which acquisition of the device information fails, that is, the authentication information specified based on the history information of the history information DB 122, may be skipped in the processing of step S101 and the subsequent processing.

The embodiment is described above. As described above, the information processing device 100 stores, in the storage unit 120 in advance, the first authentication information for accessing the image forming device 200 and the second authentication information that is information obtained by updating the first authentication information. When the information processing device 100 fails to acquire the device information of the image forming device 200 by access using the second authentication information, the information processing device 100 acquires the device information of the image forming device 200 using the first authentication information. Therefore, even when new authentication information cannot be set in the device to be managed for some reason, the information processing device 100 can access the device to be managed and appropriately acquire the device information.

While the embodiment has been described above, the present disclosure is not limited to the above embodiment and changes can be made without departing from the spirit and scope of the present disclosure. For example, although the device managed by the information processing device 100 is the image forming device in the above-described embodiment, the device managed by the information processing device 100 is not limited to the image forming device and may be any electronic device. More specifically, the device managed by the information processing device 100 may be an electronic device capable of communicating with the information processing device 100 according to a predetermined protocol such as the SNMP.

What is claimed is:

1. An information processing device for managing an image forming device, the information processing device comprising:
a storage unit configured to store first authentication information for accessing the image forming device and second authentication information that is information obtained by updating the first authentication information; and
an acquisition unit configured to acquire device information of the image forming device by accessing the image forming device, wherein
the acquisition unit acquires, when acquisition of the device information of the image forming device by access using the second authentication information fails, the device information of the image forming device using the first authentication information.

2. The information processing device according to claim 1, further comprising:
a storage processing unit configured to, when the device information of the image forming device is acquired, store identification information of the image forming device and information indicating authentication information used to acquire the device information in association with each other as history information in the storage unit, wherein
when the device information of the image forming device is newly acquired, the acquisition unit specifies authentication information used to access the image forming device based on the stored history information.

3. The information processing device according to claim 2, wherein
when acquisition of the device information of the image forming device using the authentication information specified based on the history information fails, the acquisition unit acquires the device information using authentication information selected according to a predetermined priority order among authentication information stored in the storage unit.

4. The information processing device according to claim 3, wherein
the priority order is an order according to an order in which authentication information is updated.

5. The information processing device according to claim 3, wherein
when the device information of the image forming device is acquired using authentication information different from the authentication information specified based on the history information, the storage processing unit updates the history information with information indicating the authentication information used to acquire the device information.

6. A management method for managing an image forming device, the management method comprising:
storing, in a storage unit in advance, first authentication information for accessing the image forming device and second authentication information that is information obtained by updating the first authentication information; and
acquiring device information of the image forming device using the first authentication information when acquisition of the device information of the image forming device by access using the second authentication information fails.

7. A non-transitory computer-readable storage medium storing a program, the program causing a computer of an information processing device for managing an image forming device to execute operations comprising:
a storage processing step of storing, in a storage unit, first authentication information for accessing the image forming device and second authentication information that is information obtained by updating the first authentication information; and
an acquisition step of acquiring device information of the image forming device by accessing the image forming device, wherein
in the acquisition step, when acquisition of the device information of the image forming device by access using the second authentication information fails, the device information of the image forming device is acquired using the first authentication information.
